(19) United States
(12) Patent Application Publication
(10) Pub. No.: US 2024/0294847 A1
(43) Pub. Date: Sep. 5, 2024

(54) ADDITIVE FOR AUTOMATIC DISHWASHING CYCLE, COMPOSITION, USE AND METHOD OF PREVENTING CORROSIN OF ALUMINIUM

(71) Applicant: Reckitt Benckiser Finish B.V., Hoofddorp (NL)

(72) Inventors: Marco HAAG, Heidelberg (DE); Karlheinz Ulrich HAHN, Heidelberg (DE); Rainer MÜLLER-LEIFHEIT, Heidelberg (DE)

(21) Appl. No.: 18/566,044

(22) PCT Filed: May 30, 2022
(86) PCT No.: PCT/EP2022/064530

§ 371 Date: Nov. 30, 2023

(30) Foreign Application Priority Data
Jun. 3, 2021 (GB) 2107977.7

(51) Int. Cl. C11D 3/00; C11D 3/08; C11D 3/20; C11D 17/04

(52) U.S. Cl. CPC C11D 3/0073; C11D 3/0084; C11D 3/08; C11D 3/2093; C11D 3/2096; C11D 17/045

(57) ABSTRACT

The invention relates to a dishwashing additive or detergent composition comprising a silicate source and a ring-containing organic acid; wherein the additive composition comprises between 20 mg and 5000 mg of silicate source and/or between 50 mg and 10,000 mg of ring-containing organic acid compound; and wherein the composition comprises a ratio of between 1 part silicate source to 4 parts ring-containing organic acid compound and 4 parts silicate source to 1 part ring-containing organic acid compound. The composition provides aluminium and aluminium alloy protection benefits. The invention further relates to packages and devices containing the compositions and to methods of washing dishes in an automatic dishwasher using the compositions.

### TECHNICAL FIELD OF THE INVENTION

The present invention relates to compositions for use in dishwashing applications. In particular, the invention relates to compositions for use in automatic dishwashers which provide aluminium and aluminium alloy protection benefits. The invention further relates to methods of preventing aluminium corrosion in an automatic dishwasher washing cycle.

### BACKGROUND TO THE INVENTION

Aluminium and its alloys are commonly used for components, in industrial and domestic kitchenware goods such as pots, pans, cutlery, grease traps for extractor hoods and utensils such as a garlic press, a grater and a tin opener. Screws and rivets used in pots and pans are often also made of aluminium or an alloy of aluminium.

The pH in an automatic dishwasher is typically greater than pH 8.5 and can even exceed pH 10. In these alkaline conditions, aluminium and its alloys are susceptible to corrosion. One noticeable effect of aluminium corrosion is ‘shine loss’ whereby the metallic shine commonly found on an aluminium surface fades to dullness. A further effect is discolouration to a grey or black colour, or iridescence of the aluminium components of kitchenware. Users of dishwashers often notice shine loss and discolouration of their aluminium and aluminium alloy components after very few dishwashing cycles, such is the corrosive effect that the alkaline conditions have on the aluminium components.

After frequent washing, the corrosion of aluminium and aluminium alloys can be so severe that these components begin to dissolve or considerably weaken, i.e. the components exhibit a loss in mass. This is most noticeable when the affected components are, for example, screws or rivets used to connect a handle to a pot or a pan. The result being that, when in use, the handle of the pot or pan can break off from the remainder of the pot or pan, causing the contents of the pot or pan to spill onto the user and onto the floor. In cases where the pot or pan is used to carry hot or boiling liquids, this can be very dangerous for the user and others near to the user.

Moreover, corrosion of the aluminium parts may leave sharp edges where users of the affected kitchenware goods may inadvertently injure themselves.

Further, corrosion can often cause shards of the aluminium components to be deposited in food which has been prepared using kitchenware having the corroded aluminium components. This is clearly hazardous and unpleasant for the person who unintentionally consumes the shards of metal with their food.

For years, many dishwasher detergent compositions were phosphate-based. However, due to the negative environmental impact associated with such compositions, the use of phosphate-based detergent has been banned, or at least severely restricted, in many countries, including the United States and in the European Union since 2017. While glutamic acid N,N-diacetic acid-(GLDA) and methylglycinediacetic acid (MGDA)-based detergents are considered a satisfactory phosphate-free replacement for phosphate-based detergent in terms of cleaning efficacy, the degree of aluminium corrosion is far greater when using phosphate-free detergents compared to the previously used phosphate-based detergents. As such, the problem of corrosion of aluminium and aluminium alloys in kitchenware goods has increased since the use of phosphate-free detergents has been legally required.

Attempts have been made to produce detergent compositions which do not have a detrimental effect on aluminium surfaces under alkaline conditions. However, such compositions, for example as disclosed in US 2008/0108539, rely on phosphate-based compounds to prevent corrosion of the aluminium surfaces while maintaining satisfactory cleaning efficacy.

It is known to add a linear organic acid compound and a silicate source which provides an aluminium protection effect, for example as described in WO2014027181, where methylglycinediacetic acid (MGDA) (amongst other linear acids) is mixed with silicates. By ‘linear organic acid’, we mean an organic acid which does not comprise one or more series of atoms in the organic acid compound connected to form a ring. However, the protective effect of such compositions is limited.

Embodiments of the present invention seek to ameliorate these or other disadvantages and/or to provide an improved composition which protects aluminium and aluminium alloys from corrosion; and in compositions including further detergent ingredients, also while enabling satisfactory cleaning performance of any detergent ingredients.

It is an aim of embodiments of the invention to overcome or mitigate at least one problem of the prior art, whether expressly disclosed herein or not.

### SUMMARY OF THE INVENTION

According to a first aspect of the invention, there is provided an additive composition for an automatic dishwashing cycle, the composition comprising a silicate source and a ring-containing organic acid compound: wherein the additive composition comprises between 20 mg and 5000 mg of silicate source and/or between 50 mg and 10,000 mg of ring-containing organic acid compound; and wherein the composition comprises a ratio of between 1 part silicate source to 4 parts ring-containing organic acid compound and 4 parts silicate source to 1 part ring-containing organic acid compound.

The additive compositions are therefore useful in any stage of the dishwashing cycle of an automatic dishwasher. In this specification the term “dishwashing cycle” means the entire dishwashing operation, including a main wash and a rinse stage a pre-wash, an intermediate stage, and any additional cleaning or rinsing stages.

Providing a composition comprising a silicate source and a ring-containing organic acid compound advantageously provides enhanced protection of aluminium and aluminium alloy components when used in a dishwasher, in particular in an automatic dishwasher. The inventive composition can be used either as an additional additive ingredient in state of the art dishwasher detergents, additives or rinse aid, or used as a separate product or can be also applied once or more often in any step of the dishwashing washing cycle, e.g. the inventive composition may be dosed in the pre-wash stage followed by addition of a state of the art detergent composition in the main wash cycle. The additive composition of the invention may also be released continuously during one or more stages of a dishwashing cycle, for example, as a steady release from a slow dissolving source or from a gadget arranged to dose the additive compositions continuously or at defined time intervals during one or more dishwashing cycle stages.

Surprisingly, it has been found that a combination of a ring-containing organic acid compound and a silicate source provides enhanced protection of aluminium and its alloys compared to a combination of a linear organic acid compounds and a silicate source.

Beneficially, this means that components of kitchenware made of aluminium or an aluminium alloy are significantly less susceptible to corrosion and, therefore, there is no, or at least a substantially lower, loss in mass of the aluminium and aluminium alloy components when washed using the detergent composition of the invention.

Further, by providing an additive composition comprising a silicate source and a ring-containing organic acid compound, there is a significant reduction in shine loss exhibited on kitchenware during dishwashing cycle. As such, the metallic shine commonly found on new and polished aluminium surfaces maintains its shine for far longer than if washed without utilising an additive composition comprising a silicate source and a ring-containing organic acid compound.

Advantageously, by providing an additive composition comprising a silicate source and a ring-containing organic acid compound, there is a significant reduction in discolouration or iridescence of the aluminium components of kitchenware.

Advantageously, the invention according to the first aspect provides an additive composition which can be used as part of, or in addition to, a phosphate-free detergent, which maintains a cleaning performance and prevents corrosion of aluminium and aluminium alloy components, of sufficient comparability to that of previously used phosphate-based detergents.

Further advantageously, the combination of a silicate source and a ring-containing organic acid exhibits a synergistic effect whereby each of the three factors of aluminium corrosion (i.e. mass loss, discolouration and shine loss) are significantly reduced compared to a conventional detergent composition which may comprise a silicate source only, an organic acid only, or neither a silicate source or an organic acid, as additional components.

The silicate source may be an alkali metal silicate or/and any other source that provides sufficient amount of silicate during the dishwashing process for example a material selected from the group comprising amorphous silica, colloidal silica, ester of silica and water soluble glass or any combination thereof.

Providing the silicate source as an alkali metal silicate advantageously means that the silicate source can be obtained from naturally occurring materials. Advantageously, using naturally occurring materials considerably reduces the ecological footprint of the detergent composition.

Preferably, the silicate source is a sodium silicate. By ‘sodium silicate’, we intend this to mean any chemical compound with the formula Na₂ₓSi_{y}O_{2y+x} or (Na₂O)ₓ·(SiO₂)_{y}. Such compounds may include, but are not limited to, sodium metasilicate NazSiO₃, sodium orthosilicate Na₄SiO₄, sodium pyrosilicate Na₆Si₂O₇ or disodium disilicate Na₂Si₂O₅.

Beneficially, sodium silicate can be obtained from naturally occurring materials, for example by heating a mixture of sand, soda and water. Sodium silicate may also be obtained from soda produced using the Solvay process.

The silicate source and ring-containing organic acid compound are present in a weight ratio of from about 1:4 to about 4:1. The silicate source and ring-containing organic acid compound may be preferably present in a weight ratio of from about 1:3.5 to about 3.5:1, from about 1:3 to about 3:1, from about 1:2.5 to about 2.5:1, from about 1:2 to about 2:1, from about 1:1.5 to about 1.5:1, or about 1:1. More preferably, the silicate source and ring-containing organic acid compound may be present in a weight ratio of from about 1:3 to about 3:1.

The silicate source is present in an amount of between 20 mg to 5000 mg, preferably between 50 mg and 3000 mg, more preferably between 100 mg and 2000 mg in the additive composition, and the same may therefore be released during a dishwashing cycle or stages thereof in which the additive composition is applied.

The ring-containing organic acid may have an antimicrobial action.

The ring-containing organic acid compound may be one or more C₃ to C₉, or C₆ to C₉ ring-containing organic acid(s), or mixtures thereof. The ring-containing organic acid may comprise a ring structure selected from the group comprising a cyclic compound, a polycyclic compound, a heterocyclic compound a bicyclic compound and a spiro compound. The ring-containing organic acid may comprise at least one optionally-substituted ring structure selected from the group comprising a cyclobutene, a cyclopentane, a cyclohexane, a benzene, an ethylene oxide, an ethylenimine, a trimethylene oxide, a furan, a tetrahydrofuran, a thiophene, a pyrrole, a pyrrolidine, a pyran, a pyridine, a piperidine, a imidazole, a thiazole, a dioxane, a morpholine and a pyrimidine, or combinations thereof.

In some embodiments, the ring-containing organic acid compound may comprise a benzoic acid structure or a furanone structure.

In preferred embodiments the ring-containing organic acid compound may be selected from the group comprising acetyl salycilic acid (2-acetyloxybenzoic acid), salycilic acid and ascorbic acid ((2R)-2-[(1S)-1,2-dihydroxyethyl]-3,4-dihydroxy-2H-furan-5-one), or any of their salts or esters thereof; or any mixtures thereof.

Beneficially, each of these acids are relatively cheap to produce. As such, manufacture of the inventive composition is relatively cheap in comparison to compounds which rely on complex synthetic chemicals that are often expensive to produce. Further, acetyl salicylic acid will decompose in a standard dishwashing cycle into peracetic acid and salicylic acid, which is a naturally occurring acid. As such, acetyl salicylic acid exhibits a favourable ecological footprint. Furthermore, the peracetic acid can help to boost cleaning and may have an antimicrobial action.

The ring-containing organic acid compound is present in an amount between 50 mg and 10000 mg, preferably between 70 and 7000 mg, more preferably between 100 and 5000 mg; and the same may be released during the dishwashing cycle or stages thereof to which the additive composition is applied.

Those skilled in the art will appreciate that where the term ‘acid’ compound is used herein, this does not require a single, pure acid, but also any of its salts and/or any ester thereof and any mixtures of them (for example ring-containing organic acid salts in combination with pure acids and/or acid salts) may be used.

The inventive composition may further comprise an antioxidant.

The antioxidant may an amine such as lecithin, or an amino acid such as glutamine, methionine and cysteine, or an ester such as ascorbil palmitate, ascorbil stearate and triethylcitrate, or mixtures thereof.

The additive composition may take any form known in the art. Possible forms include a powder, liquids, gel, or a tablet. The inventive composition may comprise a mixture of two or more forms. For example, the composition may comprise a non-powder component (for example a gel, or a liquid or an aqueous liquid, or mixtures thereof) and a free powder component. The free powder component may be compressed powder or non-compressed powder, or a mixture thereof.

Multi-compartment capsules may have different portions of the composition in each compartment, or the same composition in each compartment. The distinct compartments may contain any proportion of the total amount of ingredients, as desired.

Capsules may be filled with tablets, powders, gels, pastes or liquids, or a combination thereof. Capsules, especially multi-compartment capsules may comprise polyvinyl alcohol film capsules. In general, the maximum dimension of each compartment (excluding any flanges) is 8, 6, 5 or 4 cm. For example, a rounded cuboid compartment may have a length of 1 to 5 cm, especially 3.5 to 4.5 cm, a width of 1.5 to 3.5 cm, especially 2 to 3 cm, and a height of 1 to 2.5 cm, especially 1 to 2 cm, for example 1.25 to 1.75 cm.

The additive composition may be a unit-dose product.

The ring-containing organic acid compound and silicate source may comprise powder, crystals, granules or even blocks or may be mixed to form granules, crystals of blocks containing both ingredients. The granules and crystals may have a mean diameter of between 0.01 mm and 5 mm, such as between 0.05 mm and 3 mm, or between 0.1 mm and 2 mm.

According to a second aspect of the invention there is provided a detergent composition comprising an additive composition of the first aspect of the invention.

The detergent composition may include any suitable detergent ingredients, which may be selected from the group comprising a builder, a surfactant, a bleach, a bleach activator, an enzyme, an alkalinity source, a further acid source, a processing aid, a colourant, a perfume, an antifoam agent, a polymer, a foam-control agent, an anti-corrosion agent, a preservative or any combination thereof. Suitable examples of each type of detergent ingredients are listed in the section below headed “Cleaning Actives”.

The detergent composition according to the second aspect may optionally include any of the optional features of the invention according to the first aspect.

According to a third aspect, there is provided a package or device containing an additive composition according to the first aspect of the invention or a detergent composition of the second aspect of the invention.

The package or device according to the third aspect may optionally include any of the optional features of the invention according to the first or second aspect.

The package may comprise a water-soluble container or capsule. The water-soluble container or capsule may comprise a polyvinyl alcohol capsule or container, preferably a thermoformed polyvinyl alcohol capsule or container, especially a thermoformed polyvinyl alcohol multi-compartment capsule or container.

The water-soluble capsule or container may comprise or be a water-soluble film. The water-soluble film may be rigid or flexible at room temperature.

Preferably, the water-soluble capsule or container comprises or is made of a poly(vinyl alcohol) (PVOH) film. The PVOH film may be partially or fully alcoholised or hydrolysed, for example, it may be from 40 to 100%, preferably 70 to 92%, most preferably about 85% to about 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water. The film may be cast, blown or extruded. It may further be unoriented, mono-axially oriented or bi-axially oriented.

The PVOH film may be a thermoformed PVOH film.

The water-soluble container may be a multi-compartment water-soluble container. The multi-compartment water-soluble capsule or container may comprise two or more, three or more, four or more, five or more, or six or more separated compartments. Each of the compartments may be arranged side-by-side, concentrically, as sectors of a circle or in any suitable random or organised pattern The capsule or container may comprise a first PVOH film comprising a pocket and a surrounding flange, and a second PVOH film, applied as a cover across the pocket and sealed across the flange. The additive composition or detergent composition may be located in the pocket. The capsule or container may comprise a first PVOH film comprising more than one pocket, for example two or more, three or more, four or more, five or more, or six or more pockets, and a surrounding flange, and a second PVOH film, applied as a cover across each pocket and sealed across the flange. In some embodiments there are three or four pockets.

Beneficially, a multi-compartment container also allows compositions of different forms (i.e. solid form, liquid form or gel form) to be located within different compartments. Such a container is aesthetically more appealing to consumers.

Different forms of the additive composition may be located in different compartments of a multi-compartment capsule or container. For example, the package may comprise a multi-compartment package in which a first form of the additive composition is located in a first compartment, and a second form of the additive composition is located in a second compartment.

In some embodiments the package comprises a multiple-compartment capsule or container comprising at least one compartment filled with an additive composition of the first aspect of the invention or a detergent composition of the second aspect of the invention, and at least one further compartment filed with at least one detergent ingredient or detergent composition. In some embodiments at least one compartment is filled with an additive composition of the invention and at least two further compartments are filled with different detergent ingredients or detergent compositions.

The ring-containing organic acid compound and silicate source of the additive composition or detergent composition may be mixed with other ingredients or may be separated therefrom. For example the inventive composition may take the form of a multi-compartment capsule or container and the ring-containing organic acid compound and silicate source may be mixed together and located in one compartment with the remainder of any optional ingredients located in one or more other compartments: the ring-containing organic acid compound may be located in one compartment, the silicate source located in another compartment and the remainder of other optional ingredients located in one or more other compartments: or the ring-containing organic acid compound and silicate may be mixed together or separately with other optional ingredients in two or more compartments.

In other embodiments the device comprises a reservoir of the additive or detergent composition of the invention and at least one dispensing aperture through which the additive composition or detergent composition is ejected. The dispensing aperture may dispense the additive composition or detergent composition continuously or at defined or timed intervals, or may be arranged to dispense the composition at a particular stage of the wash cycle, for example during the pre-wash and/or during the main wash, or after the main wash.

The package may comprise a unit-dose format for a single use. In case of a dose for a single wash cycle, the packages of the present invention may contain at least 1 g. 2 g, 3 g, 4 g or at least 5 g of additive composition or detergent composition, such as from 1 to 50 g, especially from 5 to 30 g, in particular between 10 g and 25 g. Other ingredients may be used as fillers to reach the intended amount. These fillers may be as described hereinabove, and may be powders like sodium sulphates, crystals like sugar, liquids like water or other liquids, and the like. Further auxiliary ingredients like fragrance or dyes can also be used in such a single wash dose.

The package or device may comprise a multi-cycles package or device: that is, the package or device may be structured to release the additive composition or detergent composition of the invention across multiple cycles of washing, and may either be added to a dishwasher and left for multiple cycles or may be removed and replaced for each cycle. The multi-cycles package or device may comprise a plurality of doses of the additive or detergent composition of the invention. The plurality of doses may be arranged to release one dose at any defined time period, such as once every wash cycles, once every stage in every wash cycle or at two or more stages in every wash cycle, for example. The multi-cycle device may comprise a block of the additive composition or detergent composition of the invention in solid form which is arranged to dissolve in use to release a dose of composition at the desired time(s) during each cycle. If the package or device comprises a multi-cycles block, capsule, or gadget, for each dishwashing cycle it may comprise for example between 1 to 20 g of a composition containing sufficient amounts of the inventive composition for providing aluminium protecting composition.

One or more of the following cleaning active categories may be present in the additive composition of the invention, the detergent composition of the invention or in any detergent located in any compartment of a multi-compartment package or device of the invention, as desired. More than one ingredient from each cleaning active category may be present, if a cleaning active category is present in the additive composition, detergent composition, package or device of the invention.

### Cleaning Actives

If the inventive composition may be used as part of a dishwashing detergent, it can be used in combination with their state of the art ingredients. Those skilled in the art will appreciate that where the term “detergent” is used herein, this does also include rinse aid and other additive composition used to be applied during dishwashing in a dishwasher. The detergent composition may comprise one or more active components which may be selected from surfactants, alkalinity sources, acidity sources (especially for rinse aid and machine cleaner), builders, enzymes, polymers, anti-corrosion agents, bleach, care agents and other auxiliary ingredients like fragrance, dye, etc.

### Builder

The detergent compositions may comprise any ingredients known in the art. The detergent composition may comprise a builder. The builder may be either a phosphate-containing builder or a phosphate-free builder, or a mixture of each, as desired. In many countries, including the United States and in the European Union, phosphate builders are restricted and so phosphate-free builders are preferred. The detergent composition may comprise a secondary builder (co-builder).

The phosphate-free builder may also or alternatively comprise non-polymeric organic molecules with one or more carboxylic group(s). Builder compounds which are organic molecules comprising carboxylic groups may include citric acid, fumaric acid, tartaric acid, maleic acid, lactic acid and salts thereof. The alkali or alkaline earth metal salts of these organic compounds may be used, in particular, but not limited to, the sodium salts. The phosphate-free builder may be sodium citrate.

The phosphate-free co-builder may be one or more polycarboxylate(s) which comprise two carboxyl groups, for example, water-soluble salts of, malonic acid, (ethylenedioxy)diacetic acid, maleic acid, diglycolic acid, tartaric acid, tartronic acid and fumaric acid. The phosphate-free co-builder may be one or more polycarboxylate(s) which comprise three carboxyl groups, for example, water-soluble citrate. The phosphate-free co-builder may be one or more hydroxycarboxylic acid, for example, citric acid.

If phosphate-containing builders are to be used, the phosphate-containing builder may be selected from one or more of monophosphates, di-phosphates, tri-polyphosphates or oligomeric-polyphosphates, or its alkali metal salt, in particular, but not limited to, its sodium salt, for example sodium tripolyphosphate (STPP).

Conventional amounts of the phosphate-containing builders may be used, typically in the range of from 15% by weight to 70% by weight, or from 20% by weight to 60% by weight, or from 25% by weight to 50% by weight. If additional phosphate-free builder is included, the phosphate-free builder may be chosen from succinate based compounds. It is intended that the term ‘succinate based compound’ includes succinic acid based compounds, and such terms may be used interchangeably herein. Conventional amounts of the succinate based compounds may be used, typically in the range of from 5% by weight to 80% by weight, or from 15% by weight to 70% by weight, or from 20% by weight to 60% by weight. The compounds may be used individually or as a mixture.

The detergent composition may include other suitable builders, for example, glutamic acid N,N-diacetic acid (GLDA), methylglycinediacetic acid (MGDA). aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), a-alanine-N,N-diacetic acid (a-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N, N-diacetic acid (SMDA), tetrasodium imminosuccinate, iminodisuccinic acid (IDS) and (hydroxy)iminodisuccinic acid (HIDS) and alkali metal salts or ammonium salts thereof, or mixtures thereof.

The builder may comprise homopolymers and copolymers of polycarboxylic acids and their partially or completely neutralised salts, monomeric polycarboxylic acids and hydroxycarboxylic acids and their salts, phosphates and phosphonates, and mixtures thereof. The salts of the abovementioned compounds may be the ammonium and/or alkali metal salts, i.e. the lithium, sodium, or potassium salt.

The builder may be an organic builder.

The total amount of builder present in the detergent composition may be at least 5% by weight, at least 10% by weight, at least 15% by weight, at least 20% by weight, at least 25% by weight, at least 30% by weight, at least 35% by weight, at least 40% by weight, at least 45% by weight, or at least 50% by weight.

The total amount of builder present in the detergent composition may be in an amount of up to 80% by weight, up to 70% by weight, up to 60% by weight, up to 50% by weight, or up to 45% by weight. The actual amount used in the detergent composition may depend upon the nature of the builder used.

### Surfactant

The detergent composition may include one or more surfactant(s). The surfactant may be any of non-ionic, anionic, cationic, amphoteric or zwitterionic surface active agents, or suitable mixtures thereof. Preferably, the surfactant is a non-ionic surfactant. The non-ionic surfactant may be an ethoxylated non-ionic surfactant prepared by the reaction of a monohydroxy alkanol with 6 to 20 carbon atoms. The surfactant may have at least 12 moles, at least 16 moles, at least 20 moles, or at least 25 moles, of ethylene oxide per mole of alcohol. The non-ionic surfactant may be from a linear chain fatty alcohol with 16-20 carbon atoms and at least 12 moles, at least 16 moles, or at least 20 moles, of ethylene oxide per mole of alcohol.

The non-ionic surfactant may additionally comprise propylene oxide units in the surfactant molecule. The propylene oxide units may constitute up to 25% by weight, up to 20% by weight, or up to 15% by weight of the overall molecular weight of the non-ionic surfactant.

The surfactant may be an ethoxylated mono-hydroxy alkanols which additionally comprise polyoxyethylene-polyoxypropylene block copolymer units. The alcohol portion of the ethoxylated mono-hydroxy alkanols may constitute more than 30% by weight, more than 50% by weight, or more than 70% by weight of the overall molecular weight of the non-ionic surfactant. The non-ionic surfactant may comprise reverse block copolymers of polyoxyethylene and polyoxypropylene and block copolymers of polyoxyethylene and polyoxypropylene initiated with trimethylolpropane.

The non-ionic surfactant may be a surfactant described by the formula:

R¹O[CH₂CH(CH₃)O]X[CH₂CH₂O]Y[CH₂CH(OH)R²]

where R¹ represents a linear or branched chain aliphatic hydrocarbon group with 4-18 carbon atoms or a mixture thereof, R² represents a linear or branched chain aliphatic hydrocarbon rest with 2-26 carbon atoms or a mixture thereof, x is a value between 0.5 and 1.5, and y is a value of at least 15.

The non-ionic surfactant may be an end-capped polyoxyalkylated non-ionic surfactant of the formula:

R¹O[CH₂CH(R³)O]X[CH₂]kCH(OH)[CH₂]jOR₂

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5, more preferably k=1 and j=1. When the value of x is greater than 2, each R³ in the formula above may be different. R¹ and R² are preferably linear or branched chain, saturated or unsaturated, aliphatic or aromatic hydrocarbon groups with 6-22 carbon atoms, preferably 8 to 18 carbon atoms. For the group R³, H, methyl or ethyl is particularly preferred. Particularly preferred values for x are comprised between 1 and 20, preferably between 6 and 15.

As described above, where the value of x is greater than 2, each R³ in the formula can be different. For example, when x=3, R³ may be ethylene oxide (EO) (R³=H) or propylene oxide (PO) (R³=methyl) units which can be used in any order, for example (PO)(EO)(EO), (EO)(PO)(EO), (EO)(EO)(PO), (EO)(EO)(EO), (PO)(EO)(PO), (PO)(PO)(EO) and (PO)(PO)(PO).

The detergent composition may comprise a non-ionic surfactant comprising a mixture of alkoxylated alcohols and hydroxy-group containing alkoxylated alcohols.

The detergent composition may comprise a non-ionic surfactant in an amount of from 0.1% by weight to 20% by weight, 1% by weight to 15% by weight, or 2% to 10% by weight, based on the total weight of the detergent composition.

### Enzyme

The detergent composition may comprise one or more enzyme(s). The enzyme may be selected from the group containing protease, lipase, amylase, cellulase and peroxidase, or mixtures thereof. Preferably, the enzyme may be protease or amylase, or a mixture thereof. Advantageously, enzymes, in particular, but not limited to, protease and amylase, are especially effective in providing favourable cleaning efficacy in dishwashing detergent compositions. Any suitable species of these enzymes may be used as desired. More than one species may be used.

The detergent composition may comprise at least 0.001 mg, at least 0.01 mg, or at least 0.1 mg of active enzyme per gram of detergent composition.

The detergent composition may comprise from about 1.5 to about 10 mg, from about 1.8 to about 5 mg, or from about 2 to about 4 mg of active enzyme per gram of detergent composition.

### Bleach

The detergent composition may comprise one or more bleach additive or bleach activation catalyst. The bleach additive may be an organic peracid, for example perbenzoic acid and peroxycarboxylic acids e.g. phthalimido peroxy caproic acid (PAP). Advantageously, organic peracids do not require the use of a bleach activator or catalyst as these bleaches are active at relatively low temperatures, for example at about 30° C. and this contributes to such bleach materials being preferred according to the present invention.

The detergent composition may comprise one or more bleach activator or bleach catalyst, dependent on the nature of the bleaching compound. The bleach activator may be Tetraacetylethylenediamine (TAED). The bleach catalyst may be manganese oxalate, manganese acetate or a dinuclear manganese complex.

The detergent composition may comprise water.

### Acidity and Alkalinity

The detergent composition may comprise a source of acidity or a source of alkalinity, to obtain the desired pH on dissolution. A source of acidity may be any acidic compound, for example a polycarboxylic acid, for example citric acid. A source of alkalinity may be a carbonate or bicarbonate (such as an alkali metal or alkaline earth metal salt). A source of alkalinity may be any basic compound, for example any salt of a strong base and a weak acid. Non-limiting examples of an alkalinity source include an alkali hydroxide, alkali hydride, alkali oxide, alkali sesquicarbonate, alkali carbonate, alkali borate, alkali salt of mineral acid, alkali amine, alkaloid, or mixtures thereof. The alkalinity source may be sodium carbonate, sodium hydroxide or potassium hydroxide. The source of alkalinity may be present in an amount sufficient to give the wash liquor a pH of from about 8 to about 12, preferably from about 9 to about 11.5. The detergent composition may comprise from about 1% to about 40%, or from about 2% to 20% by weight of the composition, of a source of alkalinity.

The source of alkalinity may comprise a source of univalent ions. Beneficially, univalent ions contribute to high alkalinity and, advantageously, only minimally raise the ionic strength of the wash solution. The alkalinity source may be a metal hydroxide, for example, sodium or potassium hydroxide.

### Anti-Corrosion Agent

The detergent composition may comprise one or more anti-corrosion agent(s). Anti-corrosion agents may provide benefits against corrosion of glass and/or metal and the term encompasses agents that are intended to prevent or reduce the tarnishing of non-ferrous metals, in particular of silver and copper.

The detergent composition may comprise multivalent ions, for example zinc, bismuth and/or manganese ions. Beneficially, these multivalent ions may inhibit corrosion of glass and/or metal.

The detergent composition may comprise polymers for inhibit corrosion of glass and/or metal like polyalkylenimmines and/or polyquats.

The detergent composition may comprise organic and inorganic redox-active substances which are known as suitable for use as silver/copper corrosion inhibitors. The inorganic redox-active substances may be metal salts and/or metal complexes chosen from the group consisting of zinc, bismuth, manganese, titanium, zirconium, hafnium, vanadium, cobalt and cerium salts and/or complexes thereof, the metals being in one of the oxidation states II, III, IV, V or VI. The metal salts and/or metal complexes may be chosen from the group consisting of MnSO₄, Mn(II) citrate, Mn(II) stearate, Mn(II) acetylacetonate, Mn(II) [1-hydroxyethane-1, 1-diphosphonate], V₂O₅, V₂0, VO₂, TiOSO₄, K₂TiF₆, K₂ZrF₆, CoSO₄, Co(NO₃)₂, zinc acetate, zinc sulphate and Ce(NO₃)₂. The source of multivalent ions may be chosen from sulphates, carbonates, acetates, gluconates and metal-protein compounds.

The detergent composition may comprise one or more silver/copper anti-corrosion agent(s), for example benzotriazole (BTA) or bis-benzotriazole, or substituted derivatives thereof, for example tolyltriazole. Benzotriazole derivatives are those compounds in which the available substitution sites on the aromatic ring are partially or completely substituted, for example linear or branch-chain C₁-20 alkyl groups and hydroxyl, thio, phenyl or halogen such as fluorine, chlorine, bromine and iodine.

The detergent composition may comprise an anti-corrosion agent in an amount of from 0.01% by weight to 5% by weight, 0.05% by weight to 3% by weight, 0.1% by weight to 2.5% by weight, or 0.2% by weight to 2% by weight, based on the total weight.

### Polymer

The detergent composition may comprise one or more polymer(s). Beneficially, one or more polymer(s) may improve the cleaning performance of the detergent composition. The polymer may be a sulphonated polymer. The polymer may be a copolymer. The copolymer may be a copolymer of CH₂=CR¹—CR²R³—O—C₄H₃R⁴—SO₃X where R¹, R², R³ and R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene, or mixtures thereof.

The (co)polymer may include sulphonated monomer units, for example 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof, or mixtures thereof.

The detergent composition may comprise a sulphonated polymer in an amount of at least 0.1% by weight, at least 0.5% by weight, at least 1% by weight, at least 3% by weight, or up to 40% by weight, up to 25% by weight, up to 15% by weight, or up to 10% by weight.

### Foam Control Agent

The detergent composition may comprise one or more foam control agent(s). The one or more foam control agent(s) may be any conventionally used in this field, for example silicones and their derivatives, or paraffin oil, or mixtures thereof. The foam control agent may be present in an amount of 0.5% by weight or less.

### Preservative

The detergent composition may comprise minor, conventional, amounts of one or more preservative(s).

### Auxiliary

The detergent composition may comprise auxiliary ingredients like e.g. fragrance, dye

According to a fourth aspect, there is provided the use of a composition according to the invention in any former aspect for treating or washing soiled kitchenware. The kitchenware may comprise tableware, which may comprise at least one item selected from the group comprising crockery, cutlery, pots, pans and dishes.

The invention according to the fourth aspect may optionally include any of the optional features of the invention according to the first to third aspects.

According to a fifth aspect, there is provided a method for treating or washing kitchenware in a dishwashing machine, preferably an automatic dishwashing machine, wherein an additive composition of the first aspect, a detergent composition of the second aspect and/or a package or device of the third aspect is added to the automatic dishwashing machine.

The invention according to the fifth aspect may optionally include any of the optional features of the invention according to the former

The method of the fifth aspect, in some embodiments, may comprise, in any order, adding the ring-containing organic acid compound and silicate source (together or separately) to the wash fluid of the dishwashing machine, and separately adding the remaining ingredients of a dishwashing detergent composition to the wash fluid of the dishwashing machine. For example, the method may comprise adding the ring-containing organic acid and silicate source before or after adding the remaining ingredients. This may be achieved by providing a multi-compartment package of the invention, in which the ring-containing organic acid and silicate are in a separate compartment of a water-soluble package to the remaining ingredients, said separate compartment being configured to dissolve before or after the other compartment or compartments (or at least one other compartment), during a wash cycle. Or may be achieved by providing the invention into the prewash and/or beginning of main wash, and/or into any other step of the washing process before or after a state of the art detergent or detergent ingredients is/are dispensed.

The method for treating or washing kitchenware in a dishwashing machine may comprise adding the additive composition of the first aspect of the invention, the detergent composition according to the invention in its second aspect, or a package or device according to the invention in its third aspect, to the automatic dishwashing machine at the start of a main wash cycle, the pre-wash cycle or at the start of the final rinse cycle (or any combination thereof).

According to a sixth aspect of the invention there is provided the use of an additive composition of the first aspect, a detergent composition of the second aspect and/or a package or device of the third aspect for reducing aluminium corrosion.

The use may be for reducing aluminium corrosion of aluminium-containing kitchenware, such as pots, pans and crockery. The use may be reducing aluminium corrosion of kitchenware during a wash cycle of an automatic dishwasher.

### EXAMPLES

### Example 1—Automatic Dishwashing Detergents

The test article was a PTFE coated aluminium pan with uncovered aluminium on its outer bottom surface.

A test conventional detergent composition, PVOH film capsule with 18 g in total, (15.5 g w/o PVOH) was prepared, as follows:

| Category (w/o PVOH ) | Ingredient | Weight % |
|---|---|---|
| Bleach | Percarbonate, TAED, | 16 |
| | Catalyst | |
| Builder | Trisodium citrate | 38 |
| Co-builder/additional | HEDP, Homopolymer | 18 |
| builder | | |
| Alkali | Sodium carbonate, | 12.5 |
| | Sodium bicarbonate | |
| Binder | PEG | 3.5 |
| Enzyme | Protease, Amylase | 1.5 |
| Auxiliary | Dye, Antifoam, Perfume, | 0.5 |
| | Processing aids | |
| Surfactant | Fatty Alcohol Alkoxylate, | 8.8 |
| | EO:PO of 2:1 | |
| Protector | TTA | 0.2 |

### Aluminium Corrosion Profile:

Conventional phosphate-free detergent compositions are known to have a high corrosion effect on aluminium (i.e. high loss in mass and strong or very strong discolouration and shine loss). Detergent compositions comprising a silicate source and a ring-containing organic acid according to the present invention were found to vastly reduce this corrosion effect. The following compositions were tested, as shown in the table below, of which compositions 5 and 7 were examples of compositions of the invention; composition 1 was a control containing only detergent with no additional acid compound or silicate, and compositions 2, 3, 4, 6 were references, containing a linear or ring-containing organic acid but no silicate source, Composition 8 contains a silicate source but no linear or ring-containing organic acid, or a linear organic acid and a silicate source.

The silicate source used was Britesil® H₂O Hydrous Sodium Silicate which comprised approximately 82.5% wt. sodium silicate and approximately 17.5% wt. water.

| Compo- | | Mass | Discol- | Shine |
|---|---|---|---|---|
| sition | | loss (mg) | ouration | loss |
| No. | | After 10 dishwashing cycles | | |
| 1 | Conventional detergent | 1170.0 +/− 80 | 1.0 | 1.0 |
| | composition | | | |
| 2 | Conventional detergent | 340.0 +/− 24 | 2.0 | 2.0 |
| | composition + 3 g citric acid | | | |
| 3 | Conventional detergent | 210.0 +/− 23 | 3.0 | 3.0 |
| | composition + 3 g citric | | | |
| | acid + 1 g Britesil (RTM) | | | |
| | H2O Hydrous Sodium Silicate | | | |
| 4 | Conventional detergent | 400.0 +/− 22 | 2.0 | 2.0 |
| | composition + 3 g acetyl | | | |
| | salycilic acid | | | |
| 5 | Conventional detergent | 80.0 +/− 12 | 3.5 | 3.5 |
| | composition + 3 g acetyl | | | |
| | salycilic acid + 1 g Britesil | | | |
| | (RTM) H2O Hydrous Sodium | | | |
| | Silicate | | | |
| 6 | Conventional detergent | 410.0 +/− 24 | 2.0 | 2.0 |
| | composition + 3 g ascorbic | | | |
| | acid | | | |
| 7 | Conventional detergent | 50.0 +/− 6 | 3.0 | 3.5 |
| | composition + 3 g ascorbic | | | |
| | acid + 1 g Britesil (RTM) | | | |
| | H2O Hydrous Sodium Silicate | | | |
| 8 | Conventional detergent | 70.0 +/− 10 | 2.0 | 2.5 |
| | composition + 1 g Britesil | | | |
| | (RTM) H2O Hydrous Sodium | | | |
| | Silicate | | | |

Tests were performed using the following protocol:
Number of dishwashing cycles: 10
Dishwasher type: Miele GSL2 Lab Dishwasher
Program: P6-65° C./10 min
Water hardness: <1° GH
Soil: 16 g ballast soil in MW
Repetitions: 2 (mean score calculated)
Dosage: In each test, one of the above compositions was added to the dishwasher at the start of a main wash stage of a dishwashing cycle.

In each test, two test articles were placed inside the dishwasher before the start of the dishwashing cycle.

Scoring (with respect to discolouration and shine loss characteristics):
5=No discolouration or shine loss
4=Minor discolouration or shine loss
3=Discolouration or shine loss visible
2=Strong discolouration or shine loss
1=Very strong discolouration or shine loss

The aluminium test article was visually and gravimetrically examined.

A difference of at least 0.5 on mean scores is regarded to be a significant difference. With respect to mass loss, in addition to the mean score, the standard deviation was also calculated.

As can be observed in the table above, with composition nos. 5 and 7, a detergent composition including a combination of a silicate source and a ring-containing organic acid compound presented an overall enhanced synergistic protective effect of the aluminium with respect to mass loss, discolouration and shine loss. Comparatively, whilst compositions comprising only a silicate source as an additional component (i.e. composition 8) might provide similar range of protection on mass loss; without a ring-containing organic acid compound they were not able to achieve the protection levels of inventive compositions 5 and 7 in terms of shine loss.

Compositions comprising a linear organic acid only as an additional component (i.e. composition 2), and compositions comprising a ring-containing organic acid only as an additional component (i.e. compositions 4 and 6) showed only a limited protection on mass loss and against shine loss and discolouration compared to the conventional detergent composition (composition no. 1).

The composition containing both a linear acid (citric acid) and silicate source, composition 3, showed an antagonistic effect on mass loss compared to composition 8.

Composition 3 also showed an unfavourable performance with respect to mass loss compared to the compositions comprising a silicate source and a ring-containing organic acid (i.e. compositions 5 and 7, comprising acetyl salycilic acid and ascorbic acid, respectively), where a synergistic effect or at least a neutral effect for protection against mass loss was observed. It is also notable and surprising that compositions 5 and 7 presented an improved, performance with respect to discolouration and shine loss, compared to composition 3.

Thus, there is surprisingly a synergistic protective effect associated with the compositions of the present invention.

### Example 2—Delayed Dosing Test

The test article was a PTFE coated aluminium pan with uncovered aluminium on its outer bottom surface.

A test conventional detergent composition, PVOH film capsule with 18 g in 5 total, (15.5 g w/o PVOH) was prepared, as follows:

| Category (w/o PVOH ) | Ingredient | Weight % |
|---|---|---|
| Bleach | Percarbonate, TAED, | 16 |
| | Catalyst | |
| Builder | Trisodium citrate | 38 |
| Co-builder/additional | HEDP, Homopolymer | 18 |
| builder | | |
| Alkali | Sodium carbonate, | 12.5 |
| | Sodium bicarbonate | |
| Binder | PEG | 3.5 |
| Enzyme | Protease, Amylase | 1.5 |
| Auxiliary | Dye, Antifoam, Perfume, | 0.5 |
| | Processing aids | |
| Surfactant | Fatty Alcohol Alkoxylate, | 8.8 |
| | EO:PO of 2:1 | |
| Protector | TTA | 0.2 |

Additive compositions according to the invention were prepared as follows:

| | | Britesil | | | |
|---|---|---|---|---|---|
| Compo- | Acetyl | (RTM) H2O | | | |
| sition | salycilic | Hydrous Sodium | Mass | Discol- | Shine |
| No. | acid/mg | Silicate/mg | Loss/mg | oration | Loss |
| 1 | 0 | 0 | 1423 +/− 63 | 2.0 | 1.5 |
| 2 | 450 | 150 | 227 +/− 23 | 3.0 | 3.0 |
| 3 | 100 | 300 | 31 +/− 7 | 4.0 | 4.0 |
| 4 | 1350 | 450 | 0 +/− 4 | 4.5 | 4.5 |

Additive compositions comprising a silicate source and a ring-containing organic acid according to the present invention were found to vastly reduce the corrosion effect on aluminium (i.e. reduction of mass loss and reduced discolouration and shine loss) when added to a dishwashing cycle prior to a conventional detergent composition. The compositions were tested, as shown in the table above, of which compositions 2 to 4 were examples of additive compositions of the invention; composition 1 was a control containing no silicate source and no ring-containing organic acid. As such, only the conventional detergent composition was added to the dishwasher in the tests indicated by composition 1.

Tests were performed using following protocol:
Number of dishwashing cycles: 5
Dishwasher type: Bosch SMS46MW03
Program: Eco Wash
Water hardness: <1° GH
Soil: No ballast soil
Repetitions: 2 (mean score calculated)
Dosage: In each test, one of the above additive compositions was added to the dishwasher at the start of a pre wash stage of a dishwashing cycle.
   Approximately 22 minutes after the start of the pre-wash stage (i.e. at the beginning of the main wash stage), the conventional detergent composition was added from a dishwasher dispenser.

In each test, two test articles were placed inside the dishwasher before the start of the dishwashing cycle.

Scoring (with respect to discolouration and shine loss characteristics):
5=No discolouration or shine loss
4=Minor discolouration or shine loss
3=Discolouration or shine loss visible
2=Strong discolouration or shine loss
1=Very strong discolouration or shine loss

The aluminium test article was visually and gravimetrically examined.

A difference of at least 0.5 on mean scores is regarded to be a significant difference.

With respect to mass loss, in addition to the mean score, the standard deviation was also calculated.

As can be observed in the table above, with composition nos. 2, 3 and 4, the sequential dosing of an additive composition including a combination of a silicate source and a ring-containing organic acid compound, followed by dosing of the conventional detergent composition, presents an overall enhanced synergistic protective effect of the aluminium with respect to mass loss, discolouration and shine loss. Comparatively, in the test indicated by composition 1, where no additive composition comprising a silicate source and ring-containing organic acid was added, the conventional detergent composition presented unfavourable performance with respect to mass loss, discolouration and shine loss.

It is observed that the degree of aluminium protection increased with increasing amounts of silicate source and ring-containing organic acid compound present in the additive composition (compositions 2 and 4).

Notably, an overall enhanced synergistic protective effect of the aluminium with respect to mass loss, discolouration and shine loss is observed when the ring-containing organic acid compound and silicate source are present in a weight ratio of 3:1 (compositions 2 and 4) and when present in a weight ratio of 1:3 (composition 3).

It is notable and surprising that, compared to the tests comprising the conventional detergent composition only (composition 1), favourable results can be obtained when using relatively small amounts of silicate source and ring-containing organic acid compound in the additive composition according to the invention 5 (composition no. 2).

The above embodiments are described by way of example only. Many variations are possible without departing from the scope of the invention as defined in the appended claims.

1. An additive composition for an automatic dishwashing cycle, the composition comprising a silicate source and a ring-containing organic acid compound: wherein the additive composition comprises between 20 mg and 5000 mg of silicate source and/or between 50 mg and 10,000 mg of ring-containing organic acid compound; and wherein the composition comprises a ratio of between 1 part silicate source to 4 parts ring-containing organic acid compound and 4 parts silicate source to 1 part ring-containing organic acid compound.

2. An additive composition according to claim 1, wherein the silicate source is a sodium silicate.

3. An additive composition according to any claim 1 or 2, wherein the ring-containing organic acid compound comprises one or more C₃ to C₉ ring-containing organic acids and/or salts thereof and/or esters thereof.

4. An additive composition according to any preceding claim wherein the ring-containing organic acid compound comprises a ring structure selected from the group comprising a cyclic compound, a polycyclic compound, a heterocyclic compound a bicyclic compound and a spiro compound.

5. An additive composition according to any preceding claim wherein the ring-containing organic acid compound comprises at least a benzoic acid or furanone or/and salts thereof or/and ester thereof.

6. An additive composition according to any preceding claim, wherein the ring-containing organic acid is at least one compound selected from the group consisting of acetyl salicylic acid, ascorbic acid and salicylic acid; a salt thereof: an ester thereof; or a mixture thereof.

7. An additive composition according to any preceding claim, wherein the additive composition further comprises an antioxidant.

8. An additive composition according to claim 7, wherein the antioxidant is selected from the group consisting of lecithin, glutamine, methionine, cysteine, ascorbil palmitate, ascorbil stearate and triethylcitrate, and mixtures thereof.

9. An additive composition as claimed in any preceding claim in the form of a powder, liquid, gel, tablet, pouch or block.

10. A dishwashing detergent composition comprising an additive composition of any preceding claim: wherein the detergent composition is preferably substantially free of phosphates; and more preferably in the form of a powder, liquid, gel, tablet, pouch or block.

11. A package or device containing an additive or dishwashing detergent composition according to any one of the preceding claims: wherein the package or device is preferably a multi-compartment container, and wherein the additive or detergent composition is preferably located in at least one compartment.

12. Use of a composition according to any one of claims 1 to 10 or a package or gadget according to claim 11 for treating or washing soiled kitchenware.

13. A method of treating or washing kitchenware in a dishwashing machine, wherein a composition according to any one of claims 1 to 10 or a package or device according to claim 11 is added, preferably at the start of a main wash stage and/or a pre-wash stage, to the dishwashing machine.

14. A method of treating or washing kitchenware in a dishwashing machine according to claim 13, wherein the composition according to any one of claims 1 to 10 or a package or device according to claim 11 comprises a dosing format which releases the additive or detergent composition over a plurality of stages of a dishwashing cycle or over at least one stage of a plurality of dishwashing cycles.

15. The method of any one of claim 13 or 14, wherein the method of treatment is a method of preventing or reducing corrosion of aluminium.
